(19) United States
(12) Patent Application Publication
(10) Pub. No.: US 2004/0124591 A1
(43) Pub. Date: Jul. 1, 2004

(54) Hydro-flex seal and method for making hydro-flex seal

(76) Inventors: Stephen A. Sekulich, Foster City, MI (US); Richard N. Paulson, Fenton, MI (US); Gregory A. Watson JR., Durand, MI (US)

Correspondence Address: James C. McLaughlin, McLaughlin & McLaughlin, 1432 Duffield Road, Lennon, MI, 48449, US

(21) Appl. No.: 10/730,165

(22) Filed: Dec. 8, 2003

Related U.S. Application Data
(60) Provisional application No. 60/437,536, filed on Dec. 31, 2002.

(51) Int. Cl. F16J 15/46

(52) U.S. Cl. 277/645

(57) ABSTRACT

An improved, polytetrafluoroethylene shaft sealing element, and a method to make the sealing element: The improved element is characterized by being manufactured as one piece of a selected polytetrafluoroethylene mixture (which is conventionally clamped in a conventional housing) that has a strategically placed circumferential groove and that preferably has hydrodynamic grooves that end at a selected distance from the toe end of the seal. Optionally, the improved seal may include a wiper lip as part of the one piece of a polytetrafluoroethylene mixture. Alternatively, the improved element may have the thickness of the part of the seal bearing on the shaft tapered in its thickness (not of uniform thickness). Adjustment of these properties optimizes the pressure distribution of the part of the seal that bears on the shaft with a resultant significant increase in the effective lifetime of the seal and significant improvement in the effectiveness of the seal.

This application claims the benefit of Provisional Application 60/437536 filed Dec. 31, 2002

### TECHNICAL FIELD

The present invention principally relates to flexible seals interposed between parts that are rotating with respect to each other, such as a shaft and housing, where the major purpose of the seal is to keep the media, such as oil, present on one side of the seal from passing through to the media, such as the atmosphere, present on the other side of the seal; and more particularly to such seals having sealing elements that are made mostly of polytetrafluoroethylene (also called PTFE). Most particularly, the field of the present invention includes improvements in such seals and sealing elements, and improvements in making such seals and sealing elements.

### BACKGROUND

The need for a seal to be used to separate the oil side from the atmosphere side of a drive shaft has long been recognized. U.S. Pat. No. 2,804,325 discloses the desirability of using polytetrafluoroethylene in the shaft bearing surface of a seal (the sealing element), some of the difficulties of doing so that were met by using a “sheath” of polytetrafluoroethylene, and the desirability of the shaft bearing surface of a seal having grooves in a “reverse spiral” to pump fluid away from the sealed surface. Eventually, the “reverse spiral” grooves were named “hydrodynamic grooves,” and that name (or the equivalent of “hydro-thread”) is used herein. A series of U.S. patents issued in the mid 1970s, with Federal-Mogul Corporation as the assignee, offered improvements. The series includes U.S. Pat. Nos. 3,801,114; 3,857,156; 3,929,341; 3,939,551; 3,984,113; 3,985,487; and 4,052,502.

One of the more severe applications for a seal is to seal the rear crankshaft of diesel engines used in larger trucks. Herein, this seal application is called DRC for diesel-rear-crankshaft. In DRC applications, the seal is regularly exposed to high shaft surface speeds and a limited oil supply. The area where the sealing element contacts the shaft experiences high frictional heat generation. The elevated temperatures so produced tend to break down (carbonize) the limited oil film present in the contact area. The carbon builds up, adheres to the shaft and sealing element, and blocks the hydrodynamic grooves. Blockage of the hydrodynamic grooves results in a reduction of pumping capacity. Carbon that adheres causes increased friction and heat. Worse yet, carbon that adheres tends, sometimes dramatically, to cause shaft abrasion and to accelerate seal wear. In addition to the just mentioned factors that tend to limit seal life and to cause damage to the shaft, DRC applications typically experience relatively high amounts of dynamic shaft runout or shaft-to-bore misalignment, which also limit seal performance and life.

Prior art seals in DRC applications that used polytetrafluoroethylene in some fashion have had limited success. Such seals often performed better than seals using other elastomers, but such prior art seals fell short of meeting the extended life requirements that manufacturers demand. Prior designers sought to improve performance in DRC applications by using a sealing element with an inside diameter (ID) prior to forming that was significantly smaller than the shaft diameter. This tactic was taken to combat the relatively high amounts of dynamic shaft runout or shaft-to-bore misalignment experienced in DRC applications. Improved performance was also sought by thickening the sealing element with the expectation that seal failure due to excessive erosion of the sealing element would be postponed (by providing more sealing material to erode). Unfortunately, these schemes resulted in an increased amount of average sealing element contact area (because of a smaller sealing element ID) and an increase in seal-to-shaft pressure (because of the thicker sealing element). These increases caused an even greater amount of frictionally derived heat and temperature that exacerbated the previously noted problems, and resulted in little increase in seal life with greater shaft wear.

A seal that has a satisfactory life time, and performance, in DRC applications needs to be able significantly to reduce the generation of frictional heat while being able to be effective in the presence of shaft misalignment or runout. The present invention solves the problems of prior art seals and their sealing elements.

While the sealing element of the present invention has proven to be effective in DRC applications, which are particularly severe, the utility and application for the sealing element of the present invention is not limited to DRC applications. The unique nature of the present invention has wide applicability including DRC applications.

### SUMMARY OF THE INVENTION

The present invention includes an improved seal as demonstrated from testing and includes improvements in making such seals. The improved seal is characterized by having a sealing element manufactured as one piece of a selected polytetrafluoroethylene mixture (which is conventionally clamped in a conventional housing) that has a strategically placed circumferential groove (called the “hinge groove”) and that preferably has hydrodynamic grooves that end at a selected distance from the toe end of the seal. The area of the sealing element that is between the part of the sealing element that bears on the shaft and the part of the sealing element that is retained by the housing is the flex area. The flex area is preferably more thin than the remainder of the sealing element. Optionally and preferably, the improved sealing element may include a wiper lip as part of the one piece of a polytetrafluoroethylene mixture. The wiper lip of the present invention preferably has an ID, as machined, that is larger than the shaft OD. However, the wiper lip may have an ID that is smaller than, or equal to, the shaft OD. Alternatively, the improved seal may have the thickness of the part of the seal bearing on the shaft tapered in its thickness (not of uniform thickness).

It has been found that by adjusting certain properties one may optimize the pressure distribution of the part of the seal that bears on the shaft with a resultant significant increase in the effective life time of the seal and significant increase in the effectiveness of the seal. The adjustable properties just referred to include: the polytetrafluoroethylene mixture, the thickness of the seal element, the placement and size of the circumferential groove, the thinness of the flex area, the depth of the hydrodynamic grooves, the ending point of the hydrodynamic grooves that is distant from the toe of the seal, the presence or absence of a wiper lip, and the taper of the thickness of the part of the seal bearing on the shaft.

When desired for the purpose of excluding contaminants present on the atmosphere side of the seal, the seal of the present invention may have a wiper lip as a common component of the whole seal. It is anticipated that most seals for DRC applications will include a wiper lip. Having a wiper lip as a common component of the whole sealing element, in contrast to prior art two part seals, accrues benefits that include: no static leakage path exists between the two elements, one fewer component exists to be assembled, and there is no longer a concern as to whether the two elements are placed relative to each other the correct amount. Notwithstanding the preference in the present invention to have a wiper lip as a common component of the sealing element, it is understood that the sealing element of the present invention may be used with a conventional wiper lip, as illustrated in FIG. 2, where the wiper lip is a separate part and may be constructed of material different than the material of the other part.

The preferred method of making the wiper lip, and a method that is part of the present invention, machines the wiper lip out of the primary seal element (by spin forming) such that inherently a thin section is produced in the primary element (the thin section is called herein the flex area) that is between the part of the sealing element to bear on the shaft and the part of the sealing element clamped in the housing. In the prior art, the section that is between the part of the sealing element to bear on the shaft and the part of the sealing element clamped in the housing is of essentially the same thickness as the part of the sealing element that bears on the shaft and, in contrast to the more thin flex area of the present invention, imposes undesirably high radial loading when the section is bent.

The significance of the just described difference between the prior art and the present invention may be seen more clearly if it is assumed that both the prior art sealing element and the sealing element of the present invention have equal thicknesses in the area where the sealing element contacts the shaft, have the same amount of area contacting the shaft, and are composed of the same material. Under the assumptions: necessarily, the area that is between the part of the sealing element to bear on the shaft and the part of the sealing element clamped in the housing (the present invention's flex area) will be less thick in the present invention's sealing element than in the prior art sealing element; necessarily, the sealing element of the present invention will have less radial loading (pressure against the shaft) than the prior art sealing element because a smaller amount of material is being bent; and, necessarily, the sealing element of the present invention will produce less friction and have reduced heat generation than the prior art sealing element because of smaller radial loading. Clearly this information may be recast to show that it follows that for the same radial loading, and the same amount of area contacting the shaft, the sealing element of the present invention will be more thick in the area that contacts the shaft with a resultant longer life.

The sealing element of the present invention makes even better use of the flex area than illustrated in the preceding paragraph. Mindful of the preceding and that: (1) only a moderate amount of radial loading is desirable so as to minimize oil breakdown while maintaining seal integrity; (2) a fairly large area contacting the shaft must be used to accommodate the expected shaft misaligmnent or runout; and (3) a thicker bearing surface lasts longer than a thin bearing surface, it is clear that an optimization may be performed by the choice of material (stiffness and longevity), ID of the sealing element (shaft bearing area), thickness of bearing surface, and thickness of flex area. With the sealing element of the present invention, one may select: (1) the sealing element's ID needed due to the OD of the shaft and the expected worst case shaft misalignment or runout, (2) the desired radial loading, (3) the desired thickness of the bearing surface, and (4) the desired material based on its wearing properties. One may effect a sealing element having the just listed selected properties by: (1) manufacturing the sealing element from a billet of the desired material having the selected ID (and an OD that is compatible with the housing), (2) cutting the sealing element from the billet with a thickness that is the same as the desired thickness of the bearing surface, and, most important of all, (3) machining the flex area so as to have the desired radial loading. The ability of the present invention to adjust the effective stiffness of the flex area, thus the force produced by bending of the flex area, and thus the critical properties of the sealing element and the seal, is a significant part of the invention. The effective stiffness of the sealing element of the present invention has been adjusted, so far, by adjusting the thickness of the material in the flex area and, to a minor extent, by the selection of the material. An additional way to adjust the effective stiffness of the flex area follows.

The preferred embodiment of the present invention includes machined hydrodynamic grooves. Having one end of the hydrodynamic grooves at the toe end of the seal, and selecting the distance from the toe end of the seal where the hydrodynamic grooves end (the end point), provides another way for the present invention to adjust advantageously the effective stiffness in the flex area. This is true whether or not a wiper lip is machined. By machining hydrodynamic grooves that extend from the toe end of the seal, across the bearing surface of the seal, and some distance into the bending area (flex area) of the sealing element one effects the expected, oil-pumping properties of hydrodynamic grooves and one reduces the force produced by the bending. It makes little or no difference whether the machining begins or ends at the toe. Most frequently, the machining ends at the toe. The degree of force reduction, and attendant reduction in radial loading, is dependent on the pitch and depth of the hydrodynamic grooves, and on the point where the hydrodynamic grooves end that is distant from the toe (the end point). The pitch and depth of the hydrodynamic grooves and the point where the hydrodynamic grooves end that is distant from the toe are clearly under the control of the manufacturing process. While extending the hydrodynamic grooves into the flex area is an additional way to adjust the radial load, at times it is desirable to end machining of the hydrodynamic grooves prior to the heel of the sealing element. Ending, or starting, the machining of the hydrodynamic grooves prior to the heel of the sealing element results in a rear portion of the shaft-touching part of the sealing element having no hydrodynamic grooves (herein, called the static band). Such a static band prevents contaminants present on the atmosphere side of the seal that manage to pass any wiper lip from extending into the oil side of the seal. Clearly, where a wiper lip is not used and a contaminant, such as water, is present on the atmosphere side of the seal, it is contemplated by the present invention to use a static band and to adjust the radial load by one of the other methods herein disclosed. It is also contemplated by the present invention to use a static band (at the heel or the toe or both) when the pressure differential between the oil side of the seal and the atmosphere side of the seal warrants the use of a static band to assist in keeping the media on the two sides of the seal from mixing.

A third method that is contemplated by the present invention to adjust the effective stiffness in the flex area is the use of a strategically placed circumferential groove. (As will be discussed, the strategically placed circumferential groove has additional utility.) The preferred location of the circumferential groove (herein called the hinge groove) is just above where the flex area begins to bend away from being essentially normal to the shaft and where the wiper lip also begins to bend away in the opposite direction. Adjustment to the depth of the hinge groove and small adjustments in the position of the hinge groove provide an additional way to adjust the effective stiffness in the flex area.

However, the use of a hinge groove has an additional, valuable utility. In operation, it has been found that the use of a hinge groove results in forces that cause the primary element beneficially to hinge downward onto the shaft, and results in those forces also drawing any wiper lip downward and inward so as to effect a positive seal. When a hinge groove is used in conjunction with a spun formed wiper lip, such use has been found to allow the wiper lip to hinge downward, and inward, when the shaft enters and forms the primary sealing lip. The forces generated from forming the primary lip over the shaft O.D. are beneficially diverted back to the wiper lip. The forces continue to provide these benefits even after wear occurs!

It is possible to have, as has been mentioned, a wiper lip with an ID, as machined, that is larger than the shaft OD. A desirable utility in having a wiper lip with an ID, as machined, that is larger than the shaft OD, and yet, because of the hinge groove, able to contact the shaft when in operation, arises when initially installing the seal. Because the preferred wiper lip of the present invention does not touch the shaft while the seal is being installed, damage to the wiper lip is minimized and ease of installation is maximized. These advantages apply primarily where, during installation, the shaft enters the seal and engages the sealing element from the atmosphere side of the seal. While it is preferred to form a wiper lip with an ID that is larger than the shaft OD, the present invention encompasses forming a wiper lip with an ID that is smaller than the shaft OD.

The improvements in making such seals include steps to adjust the properties of the resultant seal so as to optimize the performance of the resultant seal. The manufacturing steps include: selecting the material from which to make the sealing element, selecting the ID and OD of the billet from which to machine the sealing element based on knowledge about the housing and shaft (including expectations of shaft dynamic runout or shaft misalignment), adjusting the radial load to be produced by the resultant sealing element by using at least one of the methods discussed previously for adjusting the effective stiffness in the flex area, adjusting the thickness of the shaft-bearing portion of the sealing element by determining where to sever the sealing element from the billet, and, optionally, forming a wiper lip with an ID that is larger than the shaft OD by spin forming. The preferred material from which to make the sealing element is (by weight): 90% virgin polytetrafluoroethylene, 5% fiber-glass, and 5% molybdenum disulfide.

The first objective of the present invention is significantly to reduce carbonizing of the sealing element's face.

The second objective of the present invention is significantly to extend the service life of the seal and sealing element.

The third objective of the present invention is to lower the cost to manufacture the seal.

The fourth objective of the present invention is to provide a very low cost way to modify the critical aspects of a sealing element during manufacture so as to optimize the characteristics of the sealing element.

The fifth objective of the present invention is to provide maximum ability for the sealing element to function satisfactorily under severe dynamic shaft runout, or shaft-to-bore misalignment.

The sixth objective is to use a hinge groove, with or without a wiper lip, so as to effect the benefits of such use as described herein.

### BRIEF DESCRIPTION OF THE DRAWINGS

FIG. 1 Depicts a prior art, one-piece seal in cross section.

FIG. 2 Depicts a prior art, two-piece seal in cross section.

FIG. 3 depicts an end view of a chuck-held billet 60 of polytetrafluoroethylene material from which the present invention is machined.

FIG. 4 depicts a cross section of FIG. 3 and the indexing tool holder 50 used in the machining of the present invention. Plunge cut tool 54 is hidden from view.

FIG. 5a is a partial view of FIG. 4 depicting the billet 60 just after the forming of hinge groove 34 with the plunge cut tool 54 at a starting point for spin forming of wiper lip 36

FIG. 5b is a partial view of FIG. 4 depicting the billet 60 just after spin forming of wiper lip 36 using single point tool 56.

FIG. 5c is a partial view of FIG. 4 depicting the billet 60 just after hydro-threads 46 have been cut by single point tool 56 with cut off tool 52 positioned to cut along parting line 62.

FIG. 6 Depicts part of a cross section of the preferred embodiment sealing element before it is installed on a shaft.

FIG. 7 Depicts part of a cross section of the preferred embodiment sealing element after it is installed on a shaft.

FIG. 8 Depicts part of a cross section of an alternate embodiment of the sealing element that has a tapered lip. A dotted line shows sealing element prior to forming and being installed on a shaft or on a shipping cylinder. A solid line shows sealing element after installation on a shaft.

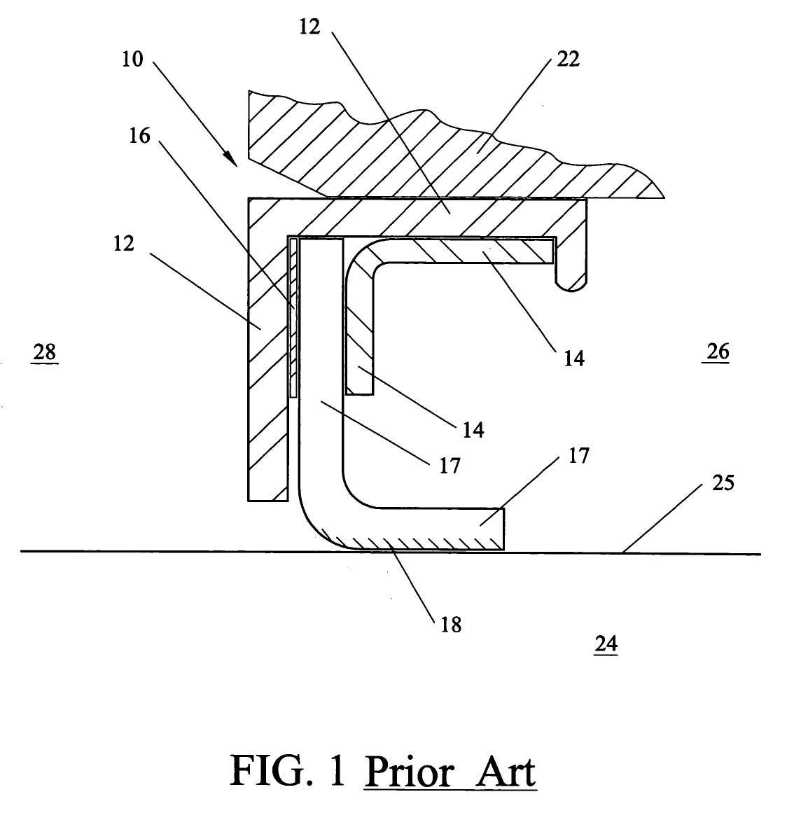

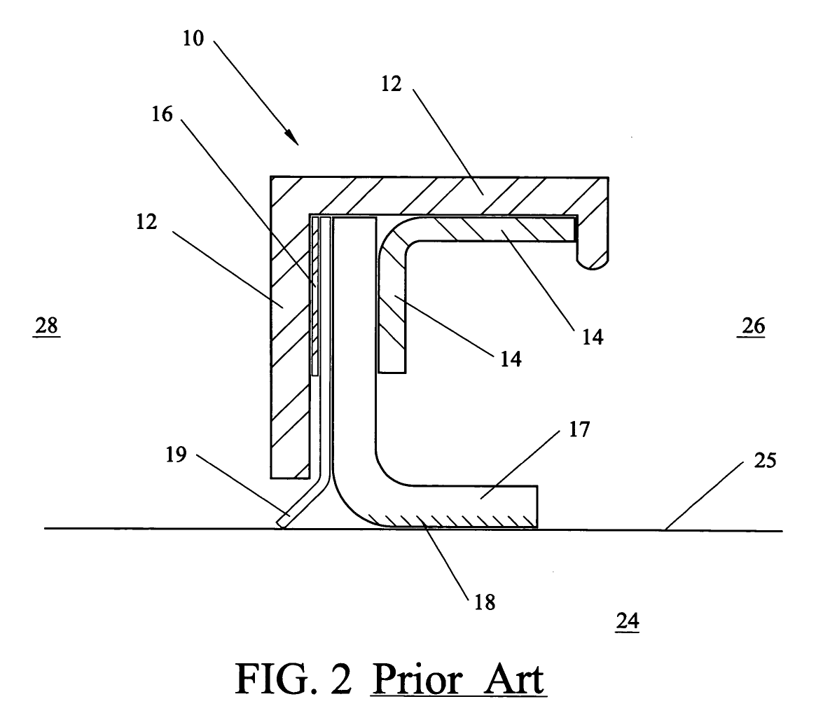

### DETAILED DESCRIPTION OF THE INVENTION

The Process of Making the Embodiments

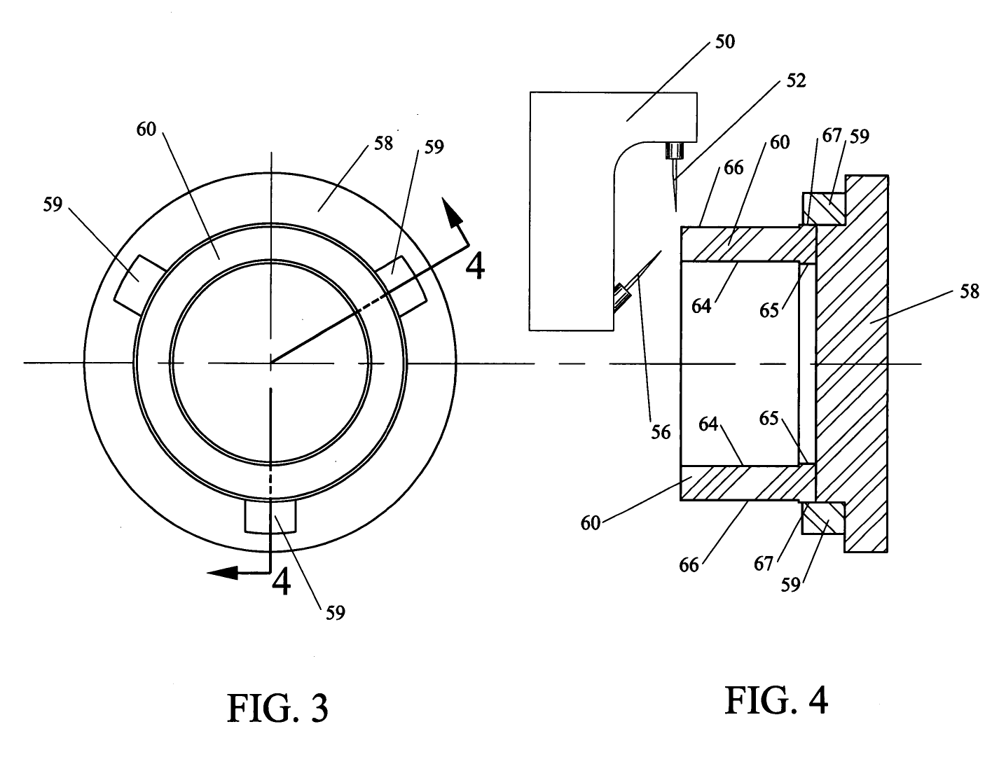

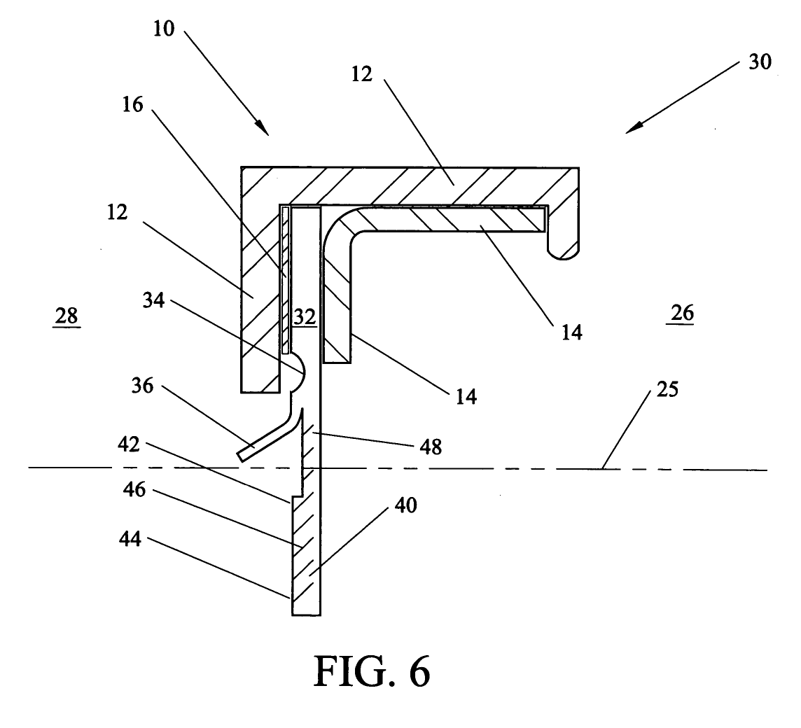

A description of the preferred method of making the preferred embodiment and the alternate embodiment (shown on FIGS. 6, 7, and 8) is facilitated by reference to FIGS. 3, 4, 5a, 5b, and 5c. It is assumed that the desired dimensions of the parts of the resultant seal are known. It is also assumed that the direction of rotation of the associated shaft is known.

The process starts with the procurement of cylinders composed of the desired polytetrafluoroethylene mixture (billet 60) that have an outside diameter (OD) slightly greater than that of the resultant seal (OD-of-billet-as-manufactured 67) and that have an inside diameter (ID) slightly smaller than that of the resultant seal (ID-of-billet-as-manufactured 65). Billet 60 is clamped in CNC chuck 58 by CNC chuck jaw 59 making every effort to have the center axis of billet 60 be coaxial with the center rotational axis of the machine. Since such alignment can not be perfect, since OD-of-billet-as-manufactured 67 and ID-of-billet-as-manufactured 65 can not be perfectly uniform, and since the ID and OD surfaces are unlikely to be perfectly smooth, the next step in the process is to machine the OD and ID of the chucked billet so as to produce OD-of-billet-as-machined 66 and ID-of-billet-as-machined 64. The resultant OD-of-billet-as-machined 66 and ID-of-billet-as-machined 64 are perfectly aligned with the rotational axis of the machine and are of the exact desired size. If the face of billet 60 is not an open face that is normal to the rotational axis of the machine, such an open face is effected. The just described steps initialize the billet and need to be done only once per billet 60. The next sets of steps are cycled to machine seal elements until the billet material is essentially exhausted.

The next steps involve indexing tool holder 50. Indexing tool holder 50 holds at least three tools: cut off tool 52, plunge cut tool 54, and single point tool 56. Indexing tool holder 50 is able, selectively, to position these tools to any coordinate.

With billet 60 clamped within CNC chuck 58 by CNC chuck jaw 59, and with billet 60 being rotated by the machine, indexing tool holder 50 moves plunge cut tool 54 against the open face of billet 60 to machine hinge groove 34. Hinge groove 34, as it would be seen from the face of billet 60, is a circular groove.

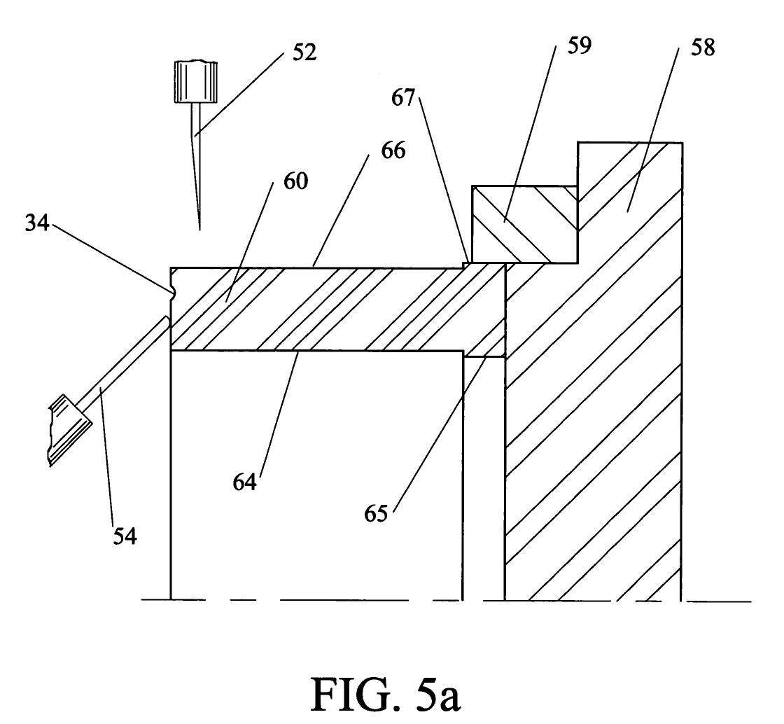

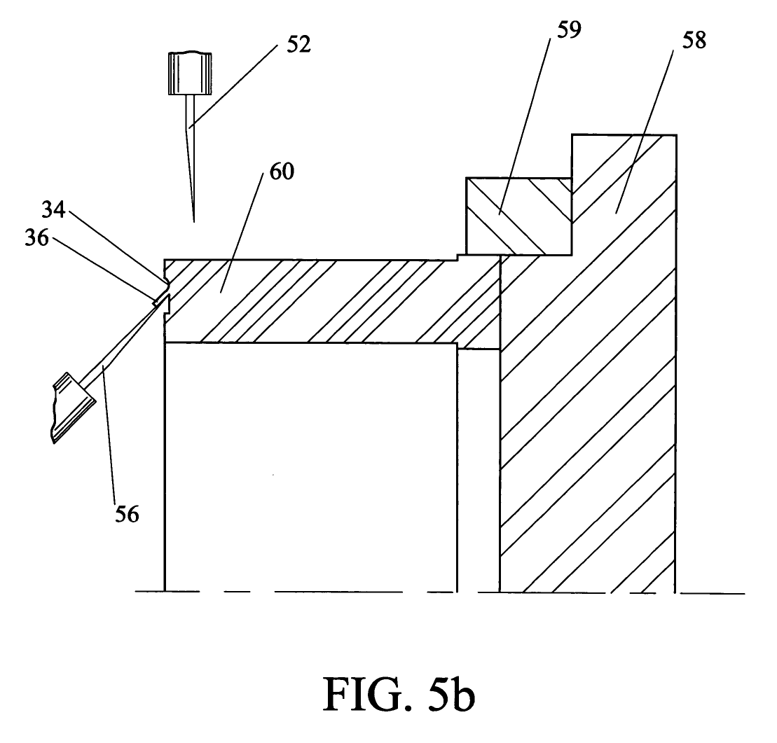

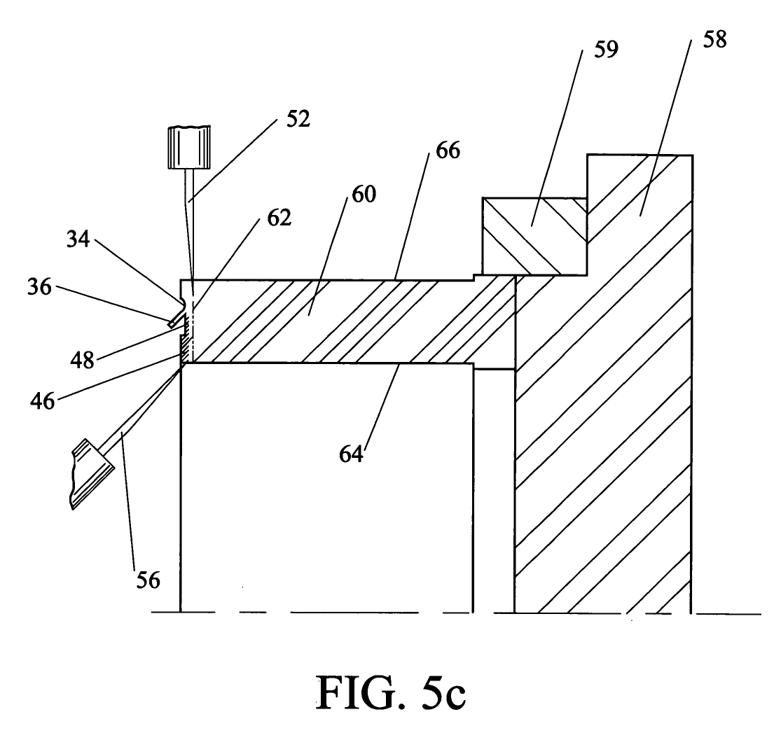

Indexing tool holder 50 then moves plunge cut tool 54 out from the face of billet 60 and downward (downward means closer to the rotational axis of the machine) to where it is desired to begin to form wiper lip 36. A shallow circular groove is machined at that position using plunge cut tool 54. FIG. 5a shows the position of plunge cut tool 54 at the end of this step. A plunge cut tool with two spaced-apart cutters could be used to effect both circular grooves at the same time.

Indexing tool holder 50 then moves plunge cut tool 54 out from the face of billet 60 and indexes single point tool 56 into the position just vacated by plunge cut tool 54. Single point tool 56 is moved inward (inward means towards CNC chuck 58) a distance from the face essentially equal to the desired thickness of the resultant wiper lip 36. Single point tool 56 is then moved upward (upward means away from the rotational axis of the machine) stopping prior to reaching hinge groove 34, and thus wiper lip 36 is effected. FIG. 5b shows the position of single point tool 56 at the end of this step.

The next step takes into account the direction of rotation of billet 60 and the known direction of rotation of the shaft to be used with the resultant seal. The relative directions of rotation must be such that, after effecting this step, the direction of rotation of the resultant hydro-thread 46 is such that oil tends to be pumped towards the oil side of the seal. With billet 60 rotating in the correct direction (as just discussed), indexing tool holder 50 moves single point tool 56 into billet 60 a fixed distance while moving single point tool 56 radially. This effects hydro-thread 46. Preferably, hydro-thread 46 is to extend from ID-of-billet-as-machined 64 to a point short of where wiper lip 36 extends. Hydro-thread 46 could extend from near ID-of-billet-as-machined 64 to a point short of where wiper lip 36 extends. The selection of the place where hydro-thread 46 ends that is away from ID-of-billet-as-machined 64 (which is called the end point) is a significant aspect of the present invention. FIG. 5c shows an end point that is essentially as far away from ID-of-billet-as-machined 64 as has been found useful by the present invention, specifically, extending through flex area 48. It is preferred to machine hydro-thread 46 starting from the just referred to end point and ending at ID-of-billet-as-machined 64. However, the present invention encompasses machining hydro-thread 46 in the opposite direction.

The next step is for indexing tool holder 50 to retract single point tool 56 from the face of billet 60, and to bring cut off tool 52 downward, severing the seal from billet 60 along parting line 62. This step also prepares the face of billet 60 for a repetition of the above steps involving indexing tool holder 50.

The steps involving indexing tool holder 50 are preferably controlled by a computer program that has been programed by a human. They may be performed manually. They may be performed manually while a computer monitors and remembers the steps, and thereafter the computer may effect the remembered steps. The minimum of the just described steps to effect a sealing element (as distinct from the earlier described steps to initialize the billet) is the effecting of hinge groove 34.

The Improvement in the Process

Two of the objectives of the present invention are: to lower the cost to manufacture the seal and sealing element, and to provide a very low cost way to modify the critical aspects of a seal during manufacture so as to optimize the characteristics of the seal. The improvements in the process accomplish these objectives.

The improvements in the process include the step wherein hinge groove 34 is formed, the step wherein hydro-thread 46 selectively extends beyond heel 42, and the preferable use of a computer to control the processing steps.

The preferred use of computer control to perform the steps of the process leads to lower cost of manufacture. Intertwined with the use of computer control is the ability, with a negligible additional cost, to modify important properties of the sealing element so as to optimize the resultant seal's characteristics.

The important properties of the sealing element that the present invention advantageously is able to modify include the depth of hinge groove 34, the thickness of the polytetrafluoroethylene part of seal 32, the end point of hydro-thread 46, and (in an alternate embodiment) the taper of the thickness of the part of the seal bearing on the shaft. It has been found that, by adjusting at least these properties, one may optimize the pressure distribution of the part of the sealing element that bears on the shaft with a resultant significant increase in the effective life time of the seal and significant increase in the effectiveness of the seal.

Description of the Preferred Embodiment and an Alternate Embodiment

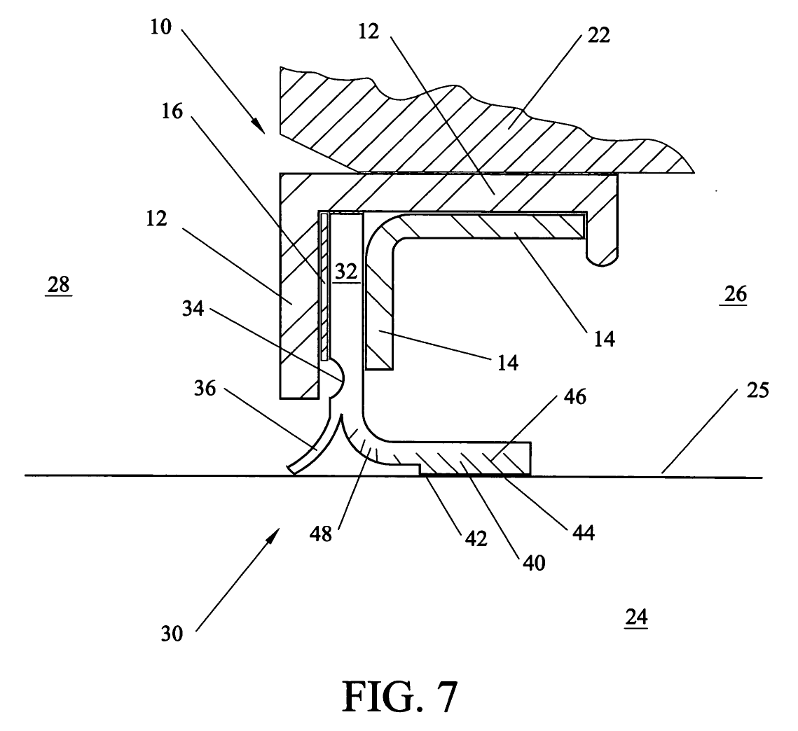

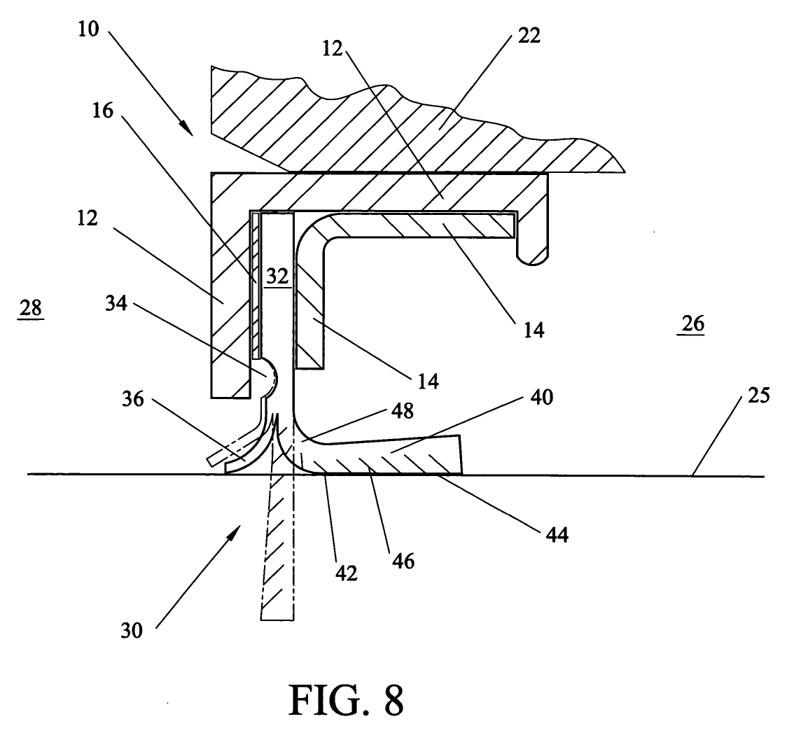

The preferred embodiment of the present invention is shown on FIG. 6 and FIG. 7. An alternate embodiment is shown on FIG. 8. The embodiments of the present invention are preferably manufactured in a manner described in previous paragraphs.

On FIG. 6, Hydro-Flex seal 30 is shown as primary seal lip 40 clamped within seal backing 10. A sandwich is made of outer case 12, gasket 16, primary seal lip 40, and inner case 14. Resilient gasket 16 is needed to prevent seepage around the end of primary seal lip 40 that is clamped, and gasket 16 may be placed other than in the preferred location shown.

FIG. 6 shows Hydro-Flex seal 30 prior to being installed around and touching shaft 24. The preferred form of Hydro-Flex seal 30 may readily be seen and, as appropriate, referenced to shaft OD 25 (shown with a dotted line on FIG. 6). The preferred embodiment has hinge groove 34, preferably implemented with a recess formed in the atmosphere side 28 of primary seal lip 40 above wiper lip 36. (“Above” means closer to the clamped end.) The preferred embodiment has a wiper lip 36 although in certain applications the ability of wiper lip 36 to keep ingress of substances from the atmosphere side 28 may be unnecessary. The preferred embodiment has hydro-threads 46 cut into primary seal lip 40 from just below the hinge of wiper lip 36 to toe 44. In some applications, hydro-thread 46 will start close to heel 42 and extend to, or near, toe 44. As will be discussed, utility exists in the choice of the ending point for cutting hydro-threads 46. The hydro-threads 46 are preferably in the form of a spiral (as seen looking down shaft 24) with a direction such that hydro-thread 46 effects a hydrodynamic function and tends to move oil towards oil side 26 of the Hydro-Flex seal 30.

FIG. 7 shows Hydro-Flex seal 30 installed between housing 22 and shaft 24. The area from heel 42 to toe 44 bears against shaft OD 25, extends towards oil side 26, and effects a very effective seal. Wiper lip 36 extends towards atmosphere side 28.

FIG. 8 shows an alternate embodiment of Hydro-Flex seal 30. The manufacture of this embodiment causes the material of primary seal lip 40 to be thicker at toe 44 than at heel 42 and to change thickness in an essentially linear fashion between. The taper may go in the opposite direction.

Not shown is the preferred method for preparing the seals of the present invention for transport to a user. The method is not amenable to being shown. The method includes placing a seal over a mandrel that has essentially the same diameter as the shaft and then sliding the preformed seal off of the mandrel onto a cylinder that has an OD that is from 0.03 inches to 0.10 inches smaller than the shaft's diameter. The seal bearing cylinders, which may be made of plastic or cardboard, are shipped to the user. This method protects the seal while in transit and provides a mechanism that significantly facilitates the user's installation of the seal onto the shaft.

The preferred material to be used in the primary seal lip 40 of the Hydro-Flex seals 30 that are the subjects here consists of virgin polytetrafluoroethylene homogeneously filled with 5% by weight of fiber-glass and 5% by weight of molybdenum disulfide. It is recognized that many other mixtures of polytetrafluoroethylene and fillers such as glass, graphite, or molybdenum may advantageously be used with the present invention and that the present invention encompasses using plastic materials that do not contain polytetrafluoroethylene.

Shaft OD, shaft hardness and smoothness, shaft rotational speed, shaft runout, and the pressure difference between the two sides of a seal are some of the factors to be considered when crafting a sealing element according to the present invention. Those, and other relevant factors, vary considerably. It is inherent that the practice of the present invention requires some experimentation. The present invention provides to one skilled in the art unprecedented tools for tailoring sealing elements to perform their intended task and discloses methods for producing such sealing elements inexpensively. The present invention provides tools for tailoring the pressure, and its distribution, of a sealing element on its shaft that include: (1) thinning the material in the flex area, (2) cutting a circumferential hinge groove in the vicinity of the flex area, (3) picking the pitch and depth of hydrodynamic grooves, (4) extending hydrodynamic grooves into the flex area, and (5) tapering the thickness of the part of the seal bearing on the shaft. The present invention also includes an optional wiper lip formed such that the sealing element is one piece and includes the possibility of a toe or heel static sealing band.

We claim:

1 A method of making a desired one piece seal element having a hinge-groove on primary sealing lip
that uses a tubular/cylindrical billet of plastic having an outside diameter (OD) slightly greater than that of the desired seal element and an inside diameter (ID) slightly smaller than that of the desired seal element, and
that uses a machine capable of rotation that includes a plunge cut tool, and a cut off tool, comprising the steps of:
initializing the billet by
procuring billets of a desired plastic;
mounting, as by clamping, the billet into the machine with the center axis of the billet close to being coaxial with the center rotational axis of the machine;
rotating the machine;
effecting an open face on the billet if an open face is not already present;
machining the OD and ID of the mounted billet so that its OD and ID are essentially the same as that of the desired seal element;
machining seal elements by cycling the steps of
moving the plunge cut tool against said open face of the rotating-mounted billet to machine a shallow, circular hinge groove; and
severing seal element from the billet by bringing cut off tool downward towards said rotational axis.

2 A method of claim 1 wherein said desired plastic of said procuring step comprises a polytetrafluoroethylene mixture.

3 A method of claim 2 wherein said polytetrafluoroethylene mixture consists, by weight, of approximately 90% virgin polytetrafluoroethylene, 5% fiber-glass, and 5% molybdenum disulfide.

4 A method of making a desired one piece seal element having a hinge-groove, and a wiper lip on primary sealing lip
that uses a tubular/cylindrical billet of plastic having an outside diameter (OD) slightly greater than that of the desired seal element and an inside diameter (ID) slightly smaller than that of the desired seal element, and
that uses a machine capable of rotation that includes a plunge cut tool, a single point tool, and a cut off tool, comprising the steps of:
initializing the billet by
procuring billets of a desired plastic;
mounting, as by clamping, the billet into the machine with the center axis of the billet close to being coaxial with the center rotational axis of the machine;
rotating the machine;
effecting an open face on the billet if an open face is not already present;
machining the OD and ID of the mounted billet so that its OD and ID are essentially the same as that of the desired seal element;
machining seal elements by cycling the steps of
moving the plunge cut tool against said open face of the rotating-mounted billet to machine a shallow, circular hinge groove;
moving plunge cut tool away from said open face of the rotating-mounted billet and then moving plunge cut tool closer to the center rotational axis of the machine than said hinge groove where it is desired to begin to form wiper lip;
moving plunge cut tool against said open face of the rotating-mounted billet to machine a shallow, circular groove and then withdrawing plunge cut tool from said open face;
replacing plunge cut tool with single point tool;
moving single point tool into said open face a distance essentially equal to the desired thickness of the desired wiper lip at the position from which plunge cut tool was just withdrawn;
moving single point tool away from the rotational axis of the machine stopping prior to reaching said hinge groove, whereby wiper lip is effected;
withdrawing single point tool from said open face; and
severing seal element from the billet by bringing cut off tool downward towards said rotational axis.

5 A method of claim 4 wherein said desired plastic of said procuring step comprises a polytetrafluoroethylene mixture.

6 A method of claim 5 wherein said polytetrafluoroethylene mixture consists, by weight, of approximately 90% virgin polytetrafluoroethylene, 5% fiber-glass, and 5% molybdenum disulfide.

7 A method of making a desired one piece seal element having a hinge-groove, and a wiper lip on primary sealing lip
that uses a tubular/cylindrical billet of plastic having an outside diameter (OD) slightly greater than that of the desired seal element and an inside diameter (ID) slightly smaller than that of the desired seal element, and
that uses a machine capable of rotation that includes a plunge cut tool with two spaced-apart cutters, a single point tool, and a cut off tool, comprising the steps of:
initializing the billet by
procuring billets of a desired plastic;
mounting, as by clamping, the billet into the machine with the center axis of the billet close to being coaxial with the center rotational axis of the machine;
rotating the machine;
effecting an open face on the billet if an open face is not already present;
machining the OD and ID of the mounted billet so that its OD and ID are essentially the same as that of the desired seal element;
machining seal elements by cycling the steps of
moving the plunge cut tool against said open face of the rotating-mounted billet to machine a shallow, circular hinge groove and to machine a second shallow, circular groove closer to the center rotational axis of the machine than said hinge groove where it is desired to begin to form wiper lip;
replacing plunge cut tool with single point tool;
moving single point tool into said open face a distance essentially equal to the desired thickness of the desired wiper lip at the position of said second shallow, circular groove;
moving single point tool away from the rotational axis of the machine stopping prior to reaching said hinge groove, whereby wiper lip is effected;
withdrawing single point tool from said open face; and
severing seal element from the billet by bringing cut off tool downward towards said rotational axis.

8 A method of claim 7 wherein said desired plastic of said procuring step comprises a polytetrafluoroethylene mixture.

9 A method of claim 8 wherein said polytetrafluoroethylene mixture consists, by weight, of approximately 90% virgin polytetrafluoroethylene, 5% fiber-glass, and 5% molybdenum disulfide.

10 A method of making a desired one piece seal element having a hinge-groove and hydro-thread on primary sealing lip
that uses a tubular/cylindrical billet of plastic having an outside diameter (OD) slightly greater than that of the desired seal element and an inside diameter (ID) slightly smaller than that of the desired seal element, and
that uses a machine capable of rotation that includes a plunge cut tool, a single point tool, and a cut off tool, comprising the steps of:
initializing the billet by
procuring billets of a desired plastic;
mounting, as by clamping, the billet into the machine with the center axis of the billet close to being coaxial with the center rotational axis of the machine;
rotating the machine;
effecting an open face on the billet if an open face is not already present;
machining the OD and ID of the mounted billet so that its OD and ID are essentially the same as that of the desired seal element;
machining seal elements by cycling the steps of
moving the plunge cut tool against said open face of the rotating-mounted billet to machine a shallow, circular hinge groove;
replacing plunge cut tool with single point tool;
cutting hydrodynamic grooves in the form of a spiral, as seen looking into said open face, by moving single point tool into said open face a fixed distance while moving single point tool radially across a portion of said open face, whereby hydro-thread is effected;
withdrawing single point tool from said open face; and
severing seal element from the billet by bringing cut off tool downward towards said rotational axis.

11 A method of claim 10 wherein said desired plastic of said procuring step comprises a polytetrafluoroethylene mixture.

12 A method of claim 11 wherein said polytetrafluoroethylene mixture consists, by weight, of approximately 90% virgin polytetrafluoroethylene, 5% fiber-glass, and 5% molybdenum disulfide.

13 A method of claim 10 wherein said portion of said step of moving single point tool radially across a portion of said open face that is part of said step of cutting hydrodynamic grooves includes said ID of the billet, whereby the resultant hydrodynamic grooves extend to the toe of the resultant seal element.

14 A method of claim 13 wherein said portion extends from said ID of the billet to said hinge groove.

15 A method of claim 13 wherein said portion extends from said ID of the billet to short of said hinge groove.

16 A method of claim 10 wherein said portion of said step of moving single point tool radially across a portion of said open face that is part of said step of cutting hydrodynamic grooves does not include said ID of the billet, whereby the resultant hydrodynamic grooves do not extend to the toe of the resultant seal element.

17 A method of making a desired one piece seal element having a hinge-groove, a wiper lip, and hydro-thread on primary sealing lip
that uses a tubular/cylindrical billet of plastic having an outside diameter (OD) slightly greater than that of the desired seal element and an inside diameter (ID) slightly smaller than that of the desired seal element, and
that uses a machine capable of rotation that includes a plunge cut tool, a single point tool, and a cut off tool, comprising the steps of:
initializing the billet by
procuring billets of a desired plastic;
mounting, as by clamping, the billet into the machine with the center axis of the billet close to being coaxial with the center rotational axis of the machine;
rotating the machine;
effecting an open face on the billet if an open face is not already present;
machining the OD and ID of the mounted billet so that its OD and ID are essentially the same as that of the desired seal element;
machining seal elements by cycling the steps of
moving the plunge cut tool against said open face of the rotating-mounted billet to machine a shallow, circular hinge groove;
moving plunge cut tool away from said open face of the rotating-mounted billet and then moving plunge cut tool closer to the center rotational axis of the machine than said hinge groove where it is desired to begin to form wiper lip;
moving plunge cut tool against said open face of the rotating-mounted billet to machine a shallow, circular groove and then withdrawing plunge cut tool from said open face;
replacing plunge cut tool with single point tool;
moving single point tool into said open face a distance essentially equal to the desired thickness of the desired wiper lip at the position from which plunge cut tool was just withdrawn;
moving single point tool away from the rotational axis of the machine stopping prior to reaching said hinge groove, whereby wiper lip is effected;
withdrawing single point tool from said open face;
cutting hydrodynamic grooves in the form of a spiral, as seen looking into said open face, by moving single point tool into said open face a fixed distance while moving single point tool radially across a portion of said open face, whereby hydro-thread is effected;
withdrawing single point tool from said open face; and
severing seal element from the billet by bringing cut off tool downward towards said rotational axis.

18 A method of claim 17 wherein said desired plastic of said procuring step comprises a polytetrafluoroethylene mixture.

19 A method of claim 18 wherein said polytetrafluoroethylene mixture consists, by weight, of approximately 90% virgin polytetrafluoroethylene, 5% fiber-glass, and 5% molybdenum disulfide.

20 A method of claim 17 wherein said portion of said step of moving single point tool radially across a portion of said open face that is part of said step of cutting hydrodynamic grooves includes said ID of the billet, whereby the resultant hydrodynamic grooves extend to the toe of the resultant seal element.

21 A method of claim 20 wherein said portion extends from said ID of the billet to said wiper lip.

22 A method of claim 20 wherein said portion extends from said ID of the billet to short of said wiper lip, whereby the resultant hydrodynamic grooves do not extend to the heel of the resultant seal element.

23 A method of claim 17 wherein said portion of said step of moving single point tool radially across a portion of said open face that is part of said step of cutting hydrodynamic grooves does not include said ID of the billet, whereby the resultant hydrodynamic grooves do not extend to the toe of the resultant seal element.

24 A method of making a desired one piece seal element having a hinge-groove, a wiper lip, and hydro-thread on primary sealing lip
that uses a tubular/cylindrical billet of plastic having an outside diameter (OD) slightly greater than that of the desired seal element and an inside diameter (ID) slightly smaller than that of the desired seal element, and
that uses a machine capable of rotation that includes a plunge cut tool with two spaced-apart cutters, a single point tool, and a cut off tool, comprising the steps of:
initializing the billet by
procuring billets of a desired plastic;
mounting, as by clamping, the billet into the machine with the center axis of the billet close to being coaxial with the center rotational axis of the machine;
rotating the machine;
effecting an open face on the billet if an open face is not already present;
machining the OD and ID of the mounted billet so that its OD and ID are essentially the same as that of the desired seal element;
machining seal elements by cycling the steps of
moving the plunge cut tool against said open face of the rotating-mounted billet to machine a shallow, circular hinge groove and to machine a second shallow, circular groove closer to the center rotational axis of the machine than said hinge groove where it is desired to begin to form wiper lip;
replacing plunge cut tool with single point tool;
moving single point tool into said open face a distance essentially equal to the desired thickness of the desired wiper lip at the position of said second shallow, circular groove;
moving single point tool away from the rotational axis of the machine stopping prior to reaching said hinge groove, whereby wiper lip is effected;
withdrawing single point tool from said open face;
cutting hydrodynamic grooves in the form of a spiral, as seen looking into said open face, by moving single point tool into said open face a fixed distance while moving single point tool radially across a portion of said open face, whereby hydro-thread is effected;
withdrawing single point tool from said open face; and
severing seal element from the billet by bringing cut off tool downward towards said rotational axis.

25 A method of claim 24 wherein said desired plastic of said procuring step comprises a polytetrafluoroethylene mixture.

26 A method of claim 25 wherein said polytetrafluoroethylene mixture consists, by weight, of approximately 90% virgin polytetrafluoroethylene, 5% fiber-glass, and 5% molybdenum disulfide.

27 A method of claim 24 wherein said portion of said step of moving single point tool radially across a portion of said open face that is part of said step of cutting hydrodynamic grooves includes said ID of the billet, whereby the resultant hydrodynamic grooves extend to the toe of the resultant seal element.

28 A method of claim 27 wherein said portion extends from said ID of the billet to said wiper lip.

29 A method of claim 27 wherein said portion extends from said ID of the billet to short of said wiper lip, whereby the resultant hydrodynamic grooves do not extend to the heel of the resultant seal element.

30 A method of claim 24 wherein said portion of said step of moving single point tool radially across a portion of said open face that is part of said step of cutting hydrodynamic grooves does not include said ID of the billet, whereby the resultant hydrodynamic grooves do not extend to the toe of the resultant seal element.

31 An improved housed shaft sealing element that has a flex area between the part of the sealing element to bear on the shaft and the part of the sealing element clamped in the housing, wherein the improvement comprises:
a flex area that is thinner than the thickness of the part of the sealing element bearing on the shaft.

32 An improved housed shaft sealing element according to claim 31, further including adjusting the thickness of said flex area to effect a desired pressure on the shaft by the part of the sealing element bearing on the shaft.

33 An improved housed shaft sealing element according to claim 31, further including a flex area that is thinner than the thickness of the part of the sealing element clamped in the housing.

34 An improved housed shaft sealing element that has a flex area between the part of the sealing element to bear on the shaft and the part of the sealing element clamped in the housing, wherein the improvement comprises:
hydrodynamic grooves that extend across a portion of the part of the sealing element bearing on the shaft that includes the ID of the part of the sealing element bearing on the shaft.

35 An improved housed shaft sealing element according to claim 34, further including extending said hydrodynamic grooves into the flex area to effect a desired pressure on the shaft by the part of the sealing element bearing on the shaft.

36 An improved housed shaft sealing element according to claim 34, wherein the depth of said hydrodynamic grooves is set so as to effect a desired pressure on the shaft by the part of the sealing element bearing on the shaft.

37 An improved housed shaft sealing element according to claim 34, wherein the pitch of said hydrodynamic grooves is set so as to effect a desired pressure on the shaft by the part of the sealing element bearing on the shaft.

38 An improved housed shaft sealing element according to claim 34, further including extending said hydrodynamic grooves short of the portion of the part of the sealing element bearing on the shaft that is distant from the ID of the part of the sealing element bearing on the shaft, whereby a static sealing band is effected.

39 An improved housed shaft sealing element that has a flex area between the part of the sealing element to bear on the shaft and the part of the sealing element clamped in the housing, wherein the improvement comprises:
hydrodynamic grooves that extend across a portion of the part of the sealing element bearing on the shaft that does not include the ID of the part of the sealing element bearing on the shaft.

40 An improved housed shaft sealing element according to claim 39, further including extending said hydrodynamic grooves into the flex area to effect a desired pressure on the shaft by the part of the sealing element bearing on the shaft.

41 An improved housed shaft sealing element according to claim 39, wherein the depth of said hydrodynamic grooves is set so as to effect a desired pressure on the shaft by the part of the sealing element bearing on the shaft.

42 An improved housed shaft sealing element according to claim 39, wherein the pitch of said hydrodynamic grooves is set so as to effect a desired pressure on the shaft by the part of the sealing element bearing on the shaft.

43 An improved housed shaft sealing element according to claim 39, further including extending said hydrodynamic grooves short of the portion of the part of the sealing element bearing on the shaft that is distant from the ID of the part of the sealing element bearing on the shaft, whereby a static sealing band is effected.

44 An improved housed shaft sealing element that has a flex area between the part of the sealing element to bear on the shaft and the part of the sealing element clamped in the housing, wherein the improvement comprises:
a circumferential hinge groove in the flex area having a depth less than the thickness of the sealing element in the flex area.

45 An improved housed shaft sealing element according to claim 44, further including adjustment of said depth of said hinge groove to effect a desired pressure on the shaft by the part of the sealing element bearing on the shaft.

46 An improved housed shaft sealing element according to claim 44, further including adjustment of the position of said hinge groove within the flex area to effect a desired pressure on the shaft by the part of the sealing element bearing on the shaft.

47 An improved housed shaft sealing element according to claim 44, further including a wiper lip.

48 An improved housed shaft sealing element according to claim 47, further including adjustment of said depth of said hinge groove to effect a desired pressure on the shaft by the part of the sealing element bearing on the shaft.

49 An improved housed shaft sealing element according to claim 47, further including adjustment of the position of said hinge groove within the flex area to effect a desired pressure on the shaft by the part of the sealing element bearing on the shaft.

50 An improved housed shaft sealing element according to claim 47, further including an ID of said wiper lip that is greater than the OD of the shaft.

51 In the crafting of an improved housed shaft sealing element that has a flex area between the part of the sealing element to bear on the shaft and the part of the sealing element clamped in the housing, a method for adjusting the pressure on the shaft by the part of the sealing element bearing on the shaft comprising the steps of:
selecting one or more methods of effecting the stiffness of the flex area selected from the group consisting of
thinning the material in the flex area,
cutting a circumferential hinge groove in the vicinity of the flex area,
picking the pitch and depth of hydrodynamic grooves,
extending hydrodynamic grooves into the flex area, and
tapering the thickness of the part of the seal bearing on the shaft; and
implementing the selected methods.

52 The method of claim 51 further including the step of cutting hydrodynamic grooves that extend across a portion of the part of the sealing element bearing on the shaft that does not include the ID of the part of the sealing element bearing on the shaft.

53 In the crafting of an improved housed shaft sealing element that has a flex area between the part of the sealing element to bear on the shaft and the part of the sealing element clamped in the housing, a method for optimizing performance of the sealing element comprises the steps of:
selecting one or more methods of effecting the stiffness of the flex area selected from the group consisting of
thinning the material in the flex area,
cutting a circumferential hinge groove in the vicinity of the flex area,
picking the pitch and depth of hydrodynamic grooves,
extending hydrodynamic grooves into the flex area, and
tapering the thickness of the part of the seal bearing on the shaft, whereby the pressure on the shaft by the part of the sealing element bearing on the shaft is optimized;
implementing the selected methods; and
providing a wiper lip.

54 The method of claim 53 further including the step of cutting hydrodynamic grooves that extend across a portion of the part of the sealing element bearing on the shaft that does not include the ID of the part of the sealing element bearing on the shaft.

55 An improved housed shaft sealing element that has a flex area between the part of the sealing element to bear on the shaft and the part of the sealing element clamped in the housing, wherein the improvement comprises:
tapering the thickness of the part of the seal bearing on the shaft.

56 An improved housed shaft sealing element according to claim 55, wherein said tapering is most thick near the flex area.

57 An improved housed shaft sealing element according to claim 55, wherein said tapering is least thick near the flex area.

58 An improved housed shaft sealing element according to claim 55 further including a circumferential hinge groove in the flex area having a depth less than the thickness of the sealing element in the flex area.

59 An improved housed shaft sealing element according to claim 58, further including adjustment of said depth of said hinge groove to effect a desired pressure on the shaft by the part of the sealing element bearing on the shaft.

60 An improved housed shaft sealing element according to claim 58, further including adjustment of the position of said hinge groove within the flex area to effect a desired pressure on the shaft by the part of the sealing element bearing on the shaft.

61 An improved housed shaft sealing element according to claim 58, further including a wiper lip.

62 An improved housed shaft sealing element according to claim 61, further including adjustment of said depth of said hinge groove to effect a desired pressure on the shaft by the part of the sealing element bearing on the shaft.

63 An improved housed shaft sealing element according to claim 61, further including adjustment of the position of said hinge groove within the flex area to effect a desired pressure on the shaft by the part of the sealing element bearing on the shaft.

64 An improved housed shaft sealing element according to claim 61, further including an ID of said wiper lip that is greater than the OD of the shaft.

65 An improved housed shaft sealing element according to claim 55 further including hydrodynamic grooves that extend across a portion of the part of the sealing element bearing on the shaft.

66 An improved housed shaft sealing element according to claim 65, further including extending said hydrodynamic grooves into the flex area to effect a desired pressure on the shaft by the part of the sealing element bearing on the shaft.

67 An improved housed shaft sealing element according to claim 65, wherein the depth of said hydrodynamic grooves is set so as to effect a desired pressure on the shaft by the part of the sealing element bearing on the shaft.

68 An improved housed shaft sealing element according to claim 65, wherein the pitch of said hydrodynamic grooves is set so as to effect a desired pressure on the shaft by the part of the sealing element bearing on the shaft.

69 An improved housed shaft sealing element according to claim 55 further including a circumferential hinge groove in the flex area having a depth less than the thickness of the sealing element in the flex area and hydrodynamic grooves that extend across a portion of the part of the sealing element bearing on the shaft.

70 An improved housed shaft sealing element according to claim 55 further including
a circumferential hinge groove in the flex area having a depth less than the thickness of the sealing element in the flex area;
hydrodynamic grooves that extend across a portion of the part of the sealing element bearing on the shaft; and
a wiper lip.
